(19) United States
(12) Patent Application Publication
(10) Pub. No.: US 2005/0214614 A1
(43) Pub. Date: Sep. 29, 2005

(54) Fuel cell system

(76) Inventor: Kyu-Nam Han, Suwon-si (KR)

Correspondence Address: McGuire Woods LLP, Suite 1800, 1750 Tysons Boulevard, McLean, VA, 22102, US

(21) Appl. No.: 11/090,796

(22) Filed: Mar. 25, 2005

(30) Foreign Application Priority Data
Mar. 25, 2004 (KR) 10-2004-0020356

(51) Int. Cl. H01M 8/10; H01M 8/12; H01M 8/04; H01M 8/00; H01M 8/18; H01M 2/00; H01M 2/02; H01M 2/14

(52) U.S. Cl. 429/32; 429/34; 429/38; 429/39; 429/20; 429/19

(57) ABSTRACT

The fuel cell system of the present invention includes at least one stack for generating electricity by a chemical reaction between hydrogen gas and oxygen. It also includes a fuel supply portion that supplies fuel containing the hydrogen gas to the stack, a first air supply portion supplying air to the stack, an adiabatic housing surrounding the stack, a second air supply portion for supplying the external air into the housing, an air mixing portion for mixing the external air in the housing with the residual air discharged from stack, and an air discharge portion for intermittently exhausting the mixed air from the air mixing portion.

### CROSS REFERENCE TO RELATED APPLICATION

This application claims priority to and the benefit of Korean Patent Application No. 10-2004-0020356 filed on Mar. 25, 2004 in the Korean Intellectual Property Office, the content of which is incorporated by reference as if fully set forth herein.

### BACKGROUND OF THE INVENTION

1. Field of the Invention

The present invention relates to a fuel cell system, and more particularly to a fuel cell system with a structure that allows residual water in the air to vaporize.

2. Description of the Background

A fuel cell produces electrical energy through a chemical reaction between oxygen and hydrogen. Typical sources of hydrogen include hydrocarbons-group materials such as methanol, ethanol, and natural gas.

Depending on the type of electrolyte used fuel cells are classified into different types, including a phosphate fuel cell, a molten carbonate fuel cell, a solid oxide fuel cell, a polymer electrolyte, and an alkali fuel cell. Although each of these different types of fuel cells operate using the same principles, they differ in the type of fuel, catalyst, and electrolyte used, as well as in drive temperature.

A polymer electrolyte membrane fuel cell (PEMFC) is an emerging technology that has excellent output characteristics, a low operating temperature, and fast starting and response characteristics. The PEMFC may be used in vehicles, at home, in buildings, and as a power source in electronic devices. The PEMFC, therefore, has a wide range of applications.

The basic components of the PEMFC are a stack, a reformer, a fuel tank, and a fuel pump. The stack forms the main body of the fuel cell. The fuel pump supplies fuel in the fuel tank to the reformer. The reformer converts the fuel to create hydrogen gas and then supplies the hydrogen gas to the stack. Next, the hydrogen gas chemically reacts with oxygen in the stack thereby generating electricity.

In the PEMFC system, the stack includes a few to a few tens of unit cells that have membrane electrode assemblies (MEAs) with separators provided on both sides of the MEAs. The MEAs comprise an anode and a cathode that are provided opposite one another with an electrolyte layer interposed inbetween. Further, the separator acts to separate each of the MEAs and may be a well-known bipolar plate. The separator also functions to provide a pathway through which hydrogen gas and oxygen are supplied to the anode and cathode of the MEAs. In addition, the separator functions as a conductor for connecting the anode and cathode of each MEA in series.

Accordingly, the hydrogen gas is supplied to the anode and the oxygen is supplied to the cathode electrode via the separators. An oxidation reaction of the hydrogen gas occurs at the anode, and a reduction reaction of the oxygen occurs at the cathode. Electricity is generated by the movement of electrons occurring during this process, and heat and water are also generated as byproducts.

In the fuel cell system described above, only a fraction of the air supplied to the cathode electrode actually undergoes reaction, while the residual unreacted air is exhausted along with a large quantity of high temperature steam. As the unreacted air containing steam is exhausted to an atmosphere at a relatively low temperature, it condenses. Therefore, when a portable electronic device or a mobile communication terminal etc. incorporates the conventional fuel cell system, high temperature steam escapes from the outer case, causing discomfort to the user.

Furthermore, the conventional fuel cell system must comprise an additional device for collecting or reusing the moisture, which causes an increase in size of the fuel cell system.

Such a device also consumes power, thereby resulting in a fuel cell system with low efficiency and performance.

### SUMMARY OF THE INVENTION

This invention provides a fuel cell system that allows steam exiting a stack to be exhausted as a vapor.

The present invention also provides a fuel cell system that does not need an additional device to reserve or reuse moisture. Instead, the present invention provides a compact fuel cell system.

Additional features of the invention will be set forth in the description which follows, and in part will be apparent from the description, or may be learned by practice of the invention.

The present invention discloses a fuel cell system that includes at least one stack that generates electricity by an electrochemical reaction between hydrogen gas and oxygen. The fuel cell system also includes a fuel supply portion that supplies fuel containing hydrogen gas to the stack, an air supply portion that supplies air to the stack, and an air discharge portion that intermittently exhausts residual air from the stack.

The present invention also discloses another fuel cell system that includes at least one stack that generates electricity by a chemical reaction of hydrogen gas and oxygen. The system also includes a fuel supply portion that supplies fuel containing hydrogen gas to the stack, a first air supply portion that supplies air to the stack, an air mixing portion that mixes external air with residual air, a second air supply portion that supplies external air to the air mixing portion, and an air discharge portion that intermittently exhausts the mixed air from the air mixing portion.

The present invention also discloses a fuel cell system that includes at least one stack that generates electricity by an electrochemical reaction between hydrogen gas and oxygen, a fuel supply portion that supplies fuel containing hydrogen gas to the stack, an air supply portion that supplies air to the stack, and an air discharge portion that intermittently exhausts the unreacted air and external air independently from the stack.

The air discharging portion includes at least one first pipeline that intermittently exhausts the unreacted air from the stack. It also includes at least one second pipeline that intermittently exhausts the external air and is coaxially connected with the first pipeline and has a larger diameter than the first pipeline. It also includes a diaphragm pump that operates at a constant pressure.

The stack is incorporated into an adiabatic housing that is provided with first, second, and third apertures that communicate with the first fuel supply portion, the air supply portion, and the air discharge portion, respectively.

The present invention also discloses a fuel cell system that includes at least one stack that generates electricity by a chemical reaction between the hydrogen gas and oxygen. The system also includes a fuel supply portion that supplies fuel containing the hydrogen gas to the stack, a first air supply portion that supplies air to the stack, a housing surrounding the stack, a second air supply portion that supplies the external air in the housing, an air mixing portion that mixes external air in the housing with residual air from the stack, and an air discharge portion that intermittently exhausts the mixed air from the air mixing portion.

It is to be understood that both the foregoing general description and the following detailed description are exemplary and explanatory and are intended to provide further explanation of the invention as claimed.

### BRIEF DESCRIPTION OF THE DRAWINGS

The above and additional features and advantages of the present invention will become more apparent by describing detailed exemplary embodiments thereof with reference to the attached drawings.

FIG. 1 is a schematic view of a fuel cell system according to a first exemplary embodiment of the present invention.

FIG. 2 is an exploded perspective view of a stack of FIG. 1.

FIG. 3 is a schematic view of a fuel cell system according to a second exemplary embodiment of the present invention.

FIG. 4 is a schematic view of a fuel cell system according to a third exemplary embodiment of the present invention.

FIG. 5 is an exploded perspective view of a stack of FIG. 4.

FIG. 6 is a schematic view of a fuel cell system according to a fourth exemplary embodiment of the present invention.

FIG. 7 is a schematic view of a fuel cell system according to a fifth exemplary embodiment of the present invention.

FIGS. 8A and 8B show enlarged cross section views of an air discharge portion of FIG. 7.

### DETAILED DESCRIPTION OF THE EMBODIMENTS

Exemplary embodiments of the present invention will now be described in detail with reference to the accompanying drawings.

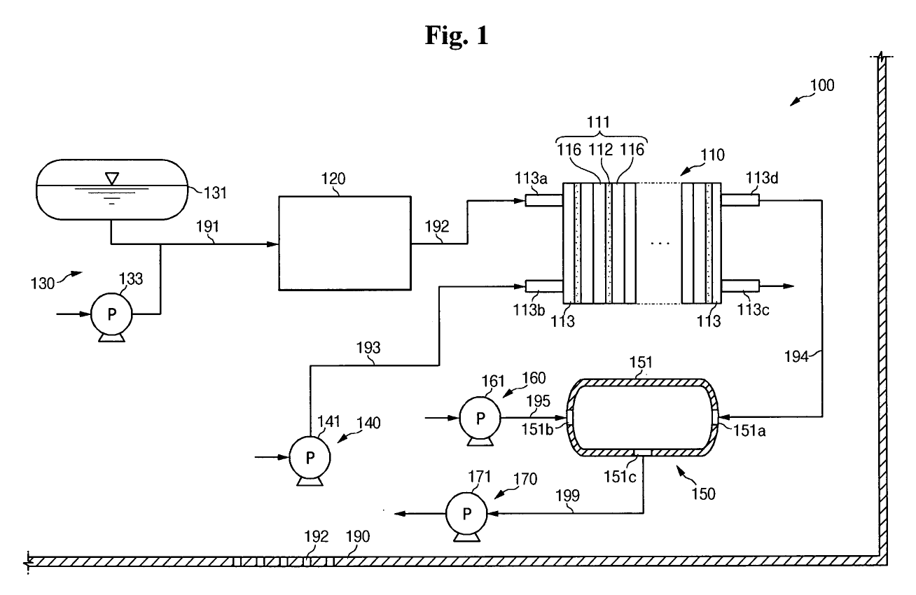

FIG. 1 is a schematic view of a fuel cell system according to an exemplary embodiment of the present invention.

In a fuel cell system 100 according to an exemplary embodiment of the present invention, the oxygen that reacts with hydrogen contained in fuel may be pure oxygen gas stored in a separate storage container or oxygen contained in air. In the following description, it will be assumed that oxygen contained in air is used. Possible fuels that contain hydrogen include methanol, ethanol, and natural gas. In the following description, fuel will be assumed to be in a liquid form and a broader sense of the word “fuel” is used, including fuels that are possibly mixed with water.

With reference to FIG. 1, the fuel cell system 100 includes a reformer 120 that converts hydrogen gas from fuel and a stack 110 that converts the chemical energy of the hydrogen gas generated from the reformer 120 and oxygen contained in air into electrical energy. It also includes a fuel supply portion 130 that supplies the fuel to the reformer 120, and an oxygen supply portion 140 (hereafter referred to as “a first air supply portion”) that supplies air to the stack 110. The fuel system 100 with this basic structure may be a PEMFC system.

The reformer 120 converts liquid fuel to generate hydrogen gas using a catalyst in its reforming portion. It also reduces the concentration of carbon monoxide contained in the hydrogen gas in its reducing portion

The catalytic methods used in the reforming portion include steam reform, partial oxidation, or a natural reaction. Further, the reducing portion uses a catalytic reaction such as a water-gas conversion method or a selective oxidation method, or a method of refining hydrogen using a separation layer.

The reformer 120 is connected with the fuel supply portion 130. The fuel supply portion 130 is provided with a fuel tank 131 that stores liquid fuel, and a fuel pump 132 that is connected with the fuel tank 131. The fuel pump 132 exhausts liquid fuel stored in the fuel tank 131 with a predetermined power. The fuel supply portion 130 may be connected with the reformer 120 through a first supply line 191.

The first air supply portion 140 is connected to the stack 110 and has a first air pump 141 that supplies external air to the stack 110 at a predetermined power. The first air supply portion 140 may be connected with the stack 110 through a third supply line 193.

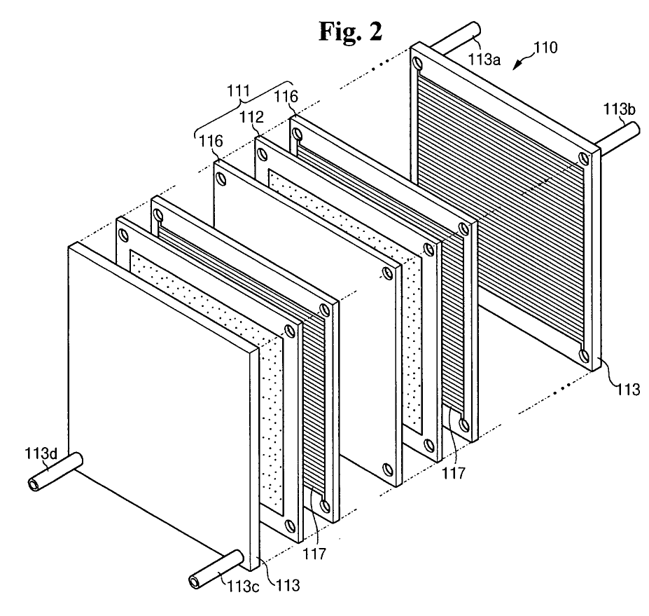

FIG. 2 is an exploded perspective view of the stack of FIG. 1.

With reference to FIGS. 1 and 2, the stack 110 includes at least one electricity generator 111 that forms a unit cell by interposing a MEA 112 between two separators 116. A plurality of such unit cells are successively combined to form the stack 110. Separators 116 mounted to opposite outermost layers of the stack 110 are defined as end plates 113.

The MEA 112 has an electrolyte layer that includes an anode and a cathode mounted to opposite surfaces thereof. The anode is supplied with hydrogen gas through the separator 116 and has a catalyst layer that converts the hydrogen gas into electrons and hydrogen ions, and a gas diffusion layer (GDL) for moving them smoothly. The cathode is supplied with air through the separator 116 and has a catalyst layer for converting oxygen gas from the air into electrons and oxygen ions, and a gas diffusion layer (GDL) for moving them smoothly. The electrolyte layer is formed from a solid polymer that is about 50 to 200 μm thick, and functions to exchange ions. The electrolyte layer moves the hydrogen ions generated in the anode to the cathode.

The separator 116 functions as a conductor that connects the anode and cathode of each MEA 112 in series and provides a pathway through which hydrogen gas and oxygen are supplied to the anode and cathode of the MEAs 112. To achieve this, the separator 116 has flow channels 117 for supplying gases required for the oxidation/reduction reaction. on the opposite surfaces of the MEAs 112.

End plates 113 have a first supply port 113a that supplies hydrogen gas from the reformer 120 at one flow channel 117 and a second supply port 113b that supplies air at another flow channel 117. In addition, they have a first discharge port 113c that exhausts unreacted hydrogen gas remaining after reaction in at least one electricity generator 111, and a second discharge port 113d that exhausts the steam that is generated during the reaction and the oxygen remaining after the reaction. The first supply port 113a may be connected with the reformer 120 through a second supply line 192. The second supply port 113b may also be connected with a third supply line 193.

Generally, during the operation of the fuel cell system 100, only a fraction of the air that is supplied to the stack 110 is reacted while the rest goes unreacted. The unreacted residual air and a large amount of the water vapor generated by the reaction are exhausted through the second discharge port 113d directly to an atmosphere of a relatively lower temperature. When the steam contacts the atmosphere, it condenses. Accordingly, in the first exemplary embodiment of the fuel cell system, it vaporizes the residual air and steam when exhausting it to the atmosphere.

To achieve this, the fuel cell system 100 includes an air mixing portion 150 that combines external air with the unreacted air containing steam that is discharged from the stack. It also includes a second air supply portion 160 that supplies the external air to the air mixing portion and an air discharge portion 170 for intermittently exhausting the mixed air from the air mixing portion 150.

The air mixing portion 150 is connected with the stack 110 and the second air supply portion 160 respectively, and is provided with a mixing tank 151 with a predetermined capacity. The mixing tank 151 is provided with a first inlet 151a in which the unreacted air from the second discharge port 113d flows, a second inlet 151b in which the external air supplied from the second air supply portion 160 flows, and an outlet 151c for exhausting the mixture of the unreacted air and the external air. The second discharge port 113d of the stack 110 is connected with the first inlet 151a of the mixing tank 151 through a fourth supply line 194. The second air supply portion 160 may be connected with the second inlet 151b through a fifth supply line 195. Also, the outlet 151c may be connected with the air discharge portion 170 through an air discharge line 199 as discussed.

The second air supply portion 160 is connected with the second inlet 151b and has a second air pump 161 for taking in the external air at a predetermined power. The second inlet 151b may be connected with the second air pump 161 through a fifth supply line 195, as discussed.

The second air supply portion 160 is not limited to the above structure with an air pump, and it may alternately have a conventional ventilating fan.

The air discharge portion 170 is connected with the outlet 151c, and has a third air pump 171 for exhausting the mixture of the external air and the unreacted air mixed in the mixing tank 151 at a predetermined power. The third air pump 171 may be connected with the outlet 151c through the air discharge line 199. Preferably, the third air pump 171 may be a diaphragm pump that intermittently exhausts the mixed air from the air mixing tank 151. In the present invention, the third pump 171 may be controlled by additional controlling means (not shown). Also, the third pump 171 may be mounted on an outer case 190 of portable communicating terminals, electronic devices, etc.

The outer case 190 incorporating the third air pump 171 is provided with through-holes 192 to enable it to exhaust the mixed air outwardly.

The operation of the fuel cell system 100 according to the first exemplary embodiment with the above structure will now be described.

First, the fuel pump 133 supplies the liquid fuel stored in the fuel tank 131 to the reformer 120 through the first supply line 191. The reformer 120 generates the hydrogen-rich gas from the liquid fuel by a steam reformer (SR) catalytic reaction while it also reduces the concentration of the carbon monoxide by a water-gas shift (WGS) catalytic reaction and a preferential CO oxidation (PROX) catalytic reaction.

Next, the hydrogen gas is supplied to the first supply port 113a through the second supply line 192 from the reformer 120, and successively to the anode of MEAs 112 through the separators 116.

At the same time, the first air pump 141 supplies external air to the second supply port 113b through the third supply line 193. This external air is supplied to the cathode of MEAs 112 through the separators 116.

If the hydrogen gas and the external air are supplied to the anode and cathode respectively in this manner, the stack 110 generates electricity, thermal energy, and water in accordance with the following set of reactions.
Anode reaction: H₂→2H++2e⁻
Cathode reaction: ½O₂+2H⁺+2e⁻→H₂O
Total reaction: H₂+½O₂→H₂O+current+thermal energy

With reference to the anode reaction, the catalyst layer of the anode converts hydrogen into electrons and protons (hydrogen ions). If a proton moves to the cathode through the electrolyte membrane, the catalyst of the cathode joins the proton and electron with oxygen, thereby generating water. Here, what is desired is for the electrons to move directly to the cathode not through the electrolyte membrane, but rather through an external circuit.

In this process, one part of the air supplied to the stack 110 is reacted while the rest passes through unreacted. The unreacted air is exhausted with a large amount of water vapor through the second discharge port 113d. Then, the first air pump 141 may be used to exhaust it.

In accordance with the exemplary embodiment, the unreacted air discharged from the second discharge port 113d is supplied to the air mixing tank 151 through the fourth supply line 194. Then, the first air pump 141 may be used to exhaust it.

At the same time, the second air pump 161 is operated such that the external air is supplied to the air mixing tank 151 through the fifth supply line 195. The flow of the external air is controlled by the second air pump 161 and is relatively larger than that of the unreacted air that also enters the air mixing tank 151. The unreacted air is mixed with the external air in the air mixing tank 151 in order to condense the water vapor in the mixture.

Next, the third air pump 171 is operated such that the mixed air from the air mixing tank 151 is exhausted through the air discharge line 199. If a pulse signal is applied to the third air pump 171, the mixed air in the air mixing tank 151 may be exhausted intermittently through the air discharge line 199. Accordingly, the mixed air is exhausted through the holes 192 of the outer case 190.

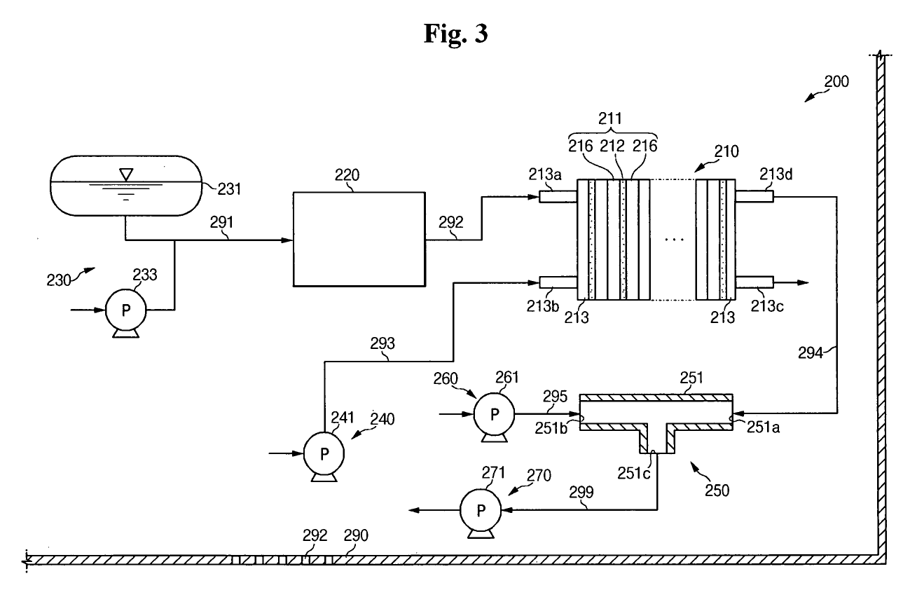

FIG. 3 is a schematic view of a fuel cell system according to a second exemplary embodiment of the present invention.

With reference to FIG. 3, the fuel cell system 200 according to a second exemplary embodiment of the present invention includes an air mixing portion 250 that mixes the residual air discharged through a second discharge port 213d from the stack 210 and the external air supplied by an air supply portion 260, that is different from the fuel cell system according to a first exemplary embodiment of the present invention. The air mixing portion 250 may comprise an air merging line 251.

The air merging line 251 is a 3-way pipeline divided into three directions in which fluids can flow in or out. Such a merging line 251 is provided with a first inlet 251a for the unreacted air from the stack 210, a second inlet 251b for the external air, and an outlet 251c for exhausting the mixed air. The second discharge port 213d of the stack 210 may be connected with the first inlet 251a through a fourth supply line 294. The second air pump 261 of the second air supply portion 260 may be connected with the second inlet 251b of the air merging line 251 through a fifth supply line 295. Also, the outlet 251c of the air merging line 251 may be connected with the third air pump 271 of the air discharge portion 270 through the air discharge line 299.

The air merging line 251 according to present invention is not limited to the above structure with an air pump, and it may also be composed such that one trough is an outlet 251c, and additional troughs are first inlets 251a and second inlets 251b.

Since other construction elements are similar to the construction elements of the first exemplary embodiment, a detailed description thereof will be omitted.

In the second exemplary embodiment, the unreacted air that is discharged through the second discharge port 213d of the stack 210 is supplied to the first inlet 251a of the air merging line 251 through the fourth supply line 294. At the same time, the second air pump 261 supplies the external dry air to the second inlet 251b of the merging line 251 through the fifth supply line 295. The unreacted air containing the water vapor from the stack 210 is mixed with the external dry air in the air merging line 251. Since the flux of the external air is larger than the flux of the unreacted air, the mixed air remains in a vaporized state.

Next, the third air pump 271 exhausts the mixed air in the air merging line 251 through the air discharge line 299. Since the third air pump 271 is a diaphragm pump, the mixed air in the air merging line 251 can be exhausted through the air discharge line 299 intermittently. For example, the mixed air is outwardly exhausted in a vaporized state by through-holes 292 of an outer case 290.

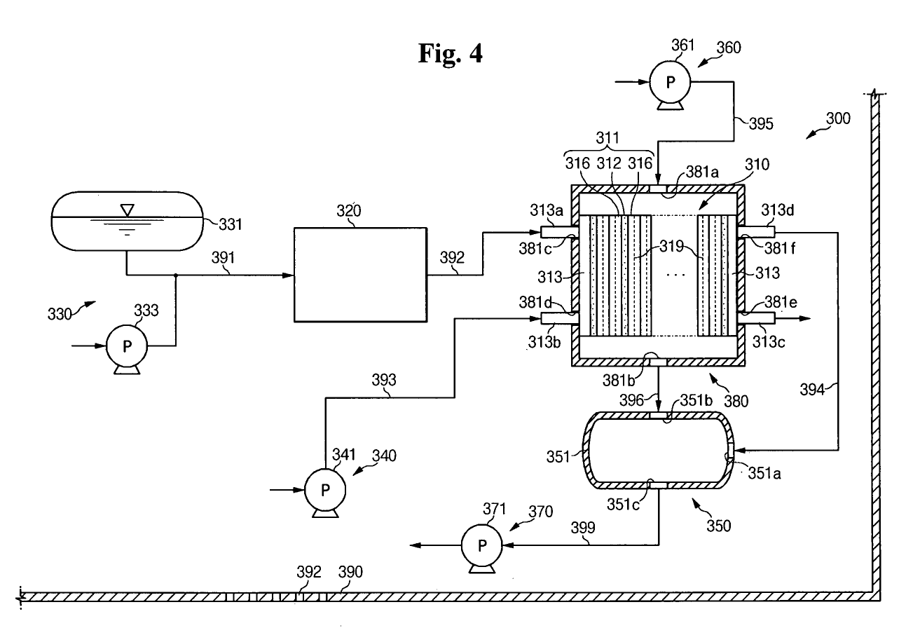

FIG. 4 is a schematic view of a fuel cell system according to a third exemplary embodiment of the present invention.

With reference to FIG. 4, the fuel cell system 300 according to the third exemplary embodiment of the present invention is constructed such that the thermal energy generated in the stack 310 heats the external air, and the heated external air is mixed with the residual air discharged from the stack 310 in order to exhaust the residual air containing water vapor.

To achieve this, the fuel cell system 300 includes at least one stack 310 for generating electricity by a chemical reaction between the hydrogen gas and oxygen. It also includes a reformer 320 that converts liquid fuel into the hydrogen gas, a fuel supply portion 330 that supplies fuel containing the hydrogen gas to the stack 310. In addition, there is a first air supply portion 340 that supplies air to the stack 310, a housing 380 surrounding the stack 310, a second air supply portion 360 that supplies the external air in the housing 380; an air mixing portion 350 for combining external air in the housing 380 with the residual air from the stack 310, and an air discharge portion 370 for intermittently exhausting the mixed air from the air mixing portion 350.

Since the reformer 320, the fuel supply portion 330, the first air supply portion 340, and the air discharge portion 370, respectively are similar to the construction of the first exemplary embodiment, a detailed description thereof will be omitted.

The housing 380 is an adiabatic evacuated vessel that surrounds the stack 310. The housing 380 is provided with an air inlet 381a and an air outlet 381b. The air inlet 381a is a passage through which the external air supplied by the second air supply portion 360 flows, while the air outlet 381b is a passage through which the inlet air is exhausted.

Also, the housing 380 is provided with a first connection port 381c connected with a first supply line 313a of the stack 310, a second connection port 381d connected with a second supply line 313b of the stack 310, a third connection port 381e connected with a first discharge line 313c of the stack 310, and a fourth connection port 381f connected with a second discharge line 313c of the stack 310.

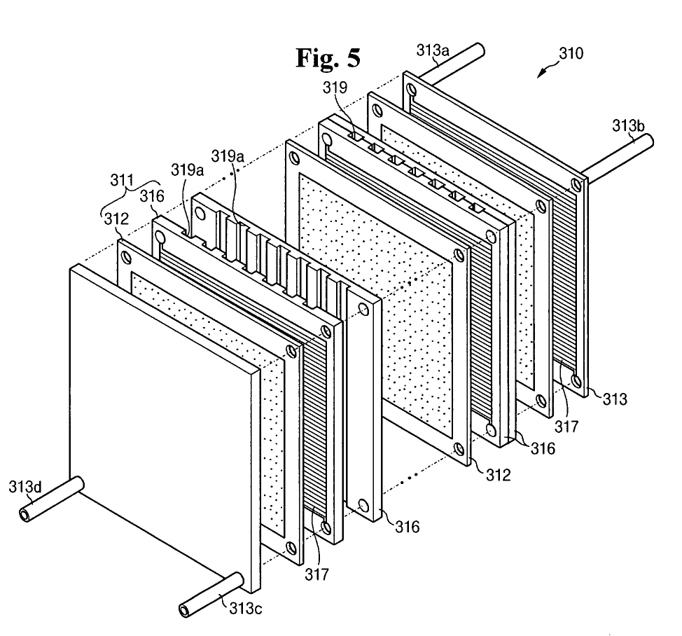

FIG. 5 is an exploded perspective view of a stack of FIG. 4.

With reference to FIGS. 4 and 5, the stack 310 used in the fuel cell system 300 is provided with a plurality of passages 319. The passages 319 allow the external air flowing into the housing 380 from the second air supply portion 360 to pass through at least one electricity generating portion 311. The external air passed through the passage 319 is heated to a predetermined temperature using the heat generated by the electricity generating portion 311. The passages 319 are formed by connecting at least one groove 319a formed on one side of the separator 316 remote from the MEAs 321 with at least one groove 319a formed on the opposite side of the separator.

The second air supply portion 360 is connected with the air inlet 381a of the housing 380 and is provided with the second air pump 361. The second inlet 381b may be connected with the second air pump 361 through a fifth supply line 395. The second air supply portion 360 is not limited to this structure comprising an air pump, as it may alternatively be provided with a conventional ventilating fan.

The air mixing portion 350 is connected with the stack 310 and housing 380 respectively, and has an air mixing tank 351 with a predetermined volume.

The air mixing tank 351 is provided with a first inlet 351a for inflowing the unreacted air from the stack 310, a second inlet 351b for flowing the external air therein, and an outlet 351c for exhausting the mixed air outwardly. The second discharge port 313d of the stack 310 may be connected with the first inlet 351a through a fourth supply line 394. The air discharge portion 381b of the housing 380 may also be connected with the second inlet 351b of the air mixing tank 351 through a sixth supply line 396. Also, the outlet 351c of the air mixing tank 351 may be connected with the third air pump 371 of the air discharge portion 370 through the air discharge line 399.

The operation of the fuel cell system 300 according to the third exemplary embodiment with the above structure will now be described.

First, as discussed in the first exemplary embodiment, the electricity generating portion 311 of the stack 310 generates heat by a chemical reaction between the hydrogen and oxygen gas. A part of the air supplied to the stack 310 reacts, while the unreacted air is exhausted along with a large amount of water vapor generated during the chemical reaction through the second discharge line 313d. Here, the unreacted air discharged through the second discharge line 313d of the stack 310 is supplied to the air mixing tank 351 through the fourth supply line 394.

At the same time, the second air pump 361 is operated such that the external dry air is supplied into the housing 380 through the fifth supply line 395. The external air passes through a plurality of passages 319 of the stack 310 incorporated into the housing 380. While it passes through the passage 319, it is heated to a predetermined temperature by the thermal energy generated in the electricity generating portion 311.

Next, the heated air is exhausted through the air discharge port 381b of the housing 381. The heated air may be exhausted through the air discharge port 381b of the housing 381 by the second air pump 361. The heated air is supplied to the mixing tank 351 through the sixth supply line 396.

Accordingly, the residual air is mixed with the heated air in the air mixing tank 351. The heated air has a relatively higher temperature than the residual air to maintain it in a vaporized state in the air mixing tank 351.

Next, the third air pump 371 exhausts the mixed air in the air mixing tank 351 through the air discharge line 399. The third air pump 371 operates with a pulse signal or a pressure sensor so that the mixed air in the air mixing tank 351 can be exhausted through the air discharge line 399. The mixed air is exhausted in a vaporized state by through holes 392 of an outer case 390.

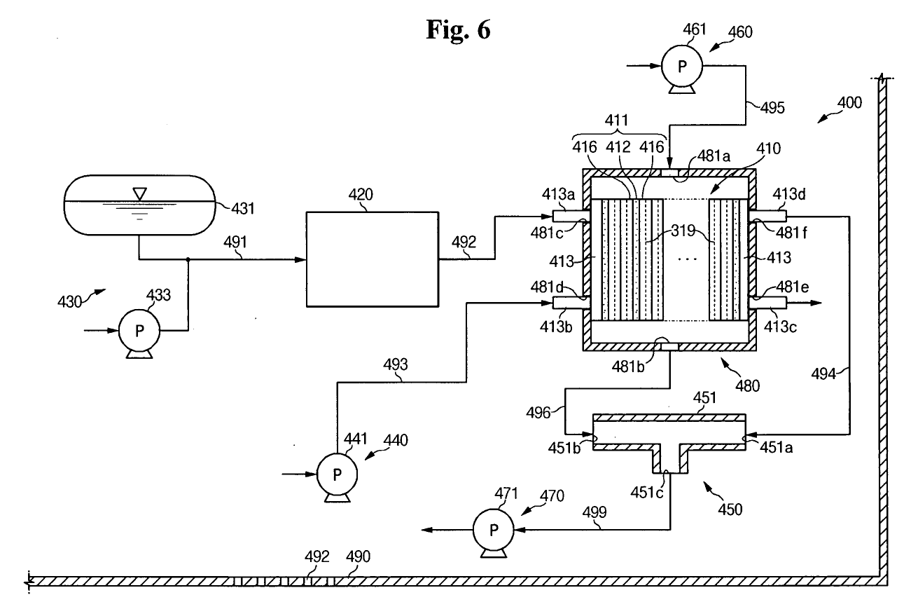

FIG. 6 is a schematic view of a fuel cell system according to a fourth exemplary embodiment of the present invention. Referring to FIG. 6, the fuel cell system 400 includes an air mixing portion 450 for mixing the unreacted air discharged through a second discharge port 413d from the stack 410 with the external air supplied by an air supply portion 460 that is different from the fuel cell system according to the third exemplary embodiment of the present invention. The air mixing portion 450 may comprise an air merging line.

The air merging line is formed into a pipeline that is divided into three directions in which fluids can proceed in or out. Such a merging line 451 has a first inlet 451a for inflowing the unreacted air from the stack 410, a second inlet 451b for flowing the external air therein, and an outlet 451c for exhausting the mixed air outwardly. The second discharge port 413d of the stack 410 may be connected with the first inlet 451a through a fourth supply line 494. The second air pump 461 of the second air supply portion 460 may be connected with the second inlet 451b of the merging line 451 through a fifth supply line 495. Also, the outlet 451c of the merging line 451 may be connected with the third air pump 471 of the air discharge portion 470 through the air discharge line 499.

Since other construction elements are similar to the construction elements of the first and third exemplary embodiments, a detailed description will be omitted.

In the fourth exemplary embodiment, the unreacted air that is discharged through the second discharge port 413d of the stack 410 is supplied to the first inlet 451a of the air merging line 451 through the fourth supply line 494.

At the same time, a second air supply portion 460 supplies the relatively dry external air into the housing 480 through the fifth supply line 495. The external air passes through a plurality of passages 319 of the stack 410 incorporated into the housing 480. While passing through the passage 319, it is heated to a predetermined temperature by the thermal energy generated in the electricity generating portion 411.

Next, the heated air is exhausted through the air discharge port 481b of the housing 480. The heated air is supplied to the second inlet 451b of the merging line 451 through a sixth supply line 496.

Accordingly, the unreacted air is mixed with the heated air in the air mixing tank 451. The heated air has a relatively higher temperature than that of the residual air to maintain it in a vaporized state in the air mixing tank 451.

Next, the third air pump 471 is operated such that the mixed air in the air merging line 451 is exhausted through the air discharge line 499. Since the third air pump 471 is a diaphragm pump, the mixed air in the air merging line 451 can be exhausted through the air discharge line 499 intermittently. For example, the mixed air is intermittently exhausted by through holes 492 of an outer case 490.

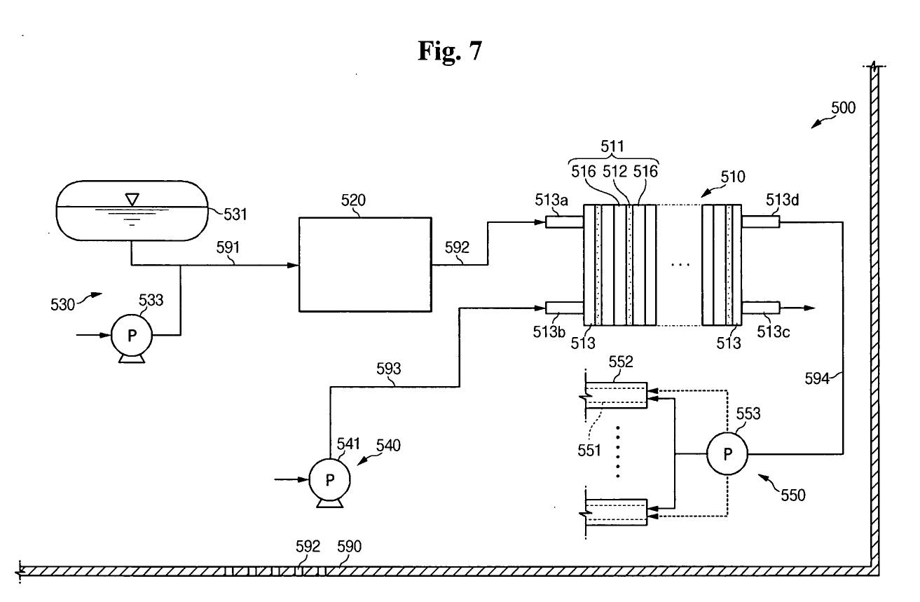

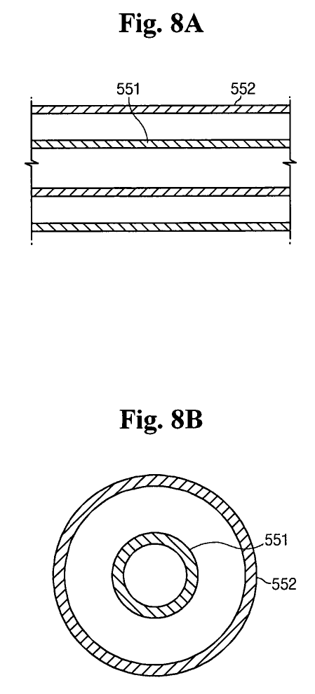

FIG. 7 is a schematic view of a fuel cell system according to a fifth exemplary embodiment of the present invention, and FIG. 8a and FIG. 8b show an enlarged cross section view of an air discharge portion of FIG. 7.

With reference to FIG. 7, FIG. 8a and FIG. 8b, the unreacted air exhausted from the stack 510 is not mixed with the external air as it was in the first through fourth exemplary embodiments of the present invention. Instead, the fuel cell system 500 includes an air discharge portion 550 that allows the unreacted air and the external air to independently exhaust to the atmosphere simultaneously at predetermined intervals.

The air discharging portion 550 includes at least one first pipeline 551 for intermittently exhausting unreacted air from the stack and at least one second pipeline 552 for exhausting the external air that is coaxial with the first pipeline 551 and has a larger diameter.

In addition, it includes a diaphragm pump 553 that simultaneously exhausts the external air and unreacted air when the internal pressure of the first and second pipelines 551 and 552 is constant.

The first pipeline 551 is a cylindrical pipe that has a certain inner diameter and is connected to a second discharge port 513d of the stack 510 through which the unreacted air containing a large amount of steam and hot water is exhausted.

The second pipeline 552 is coaxial with and surrounds the periphery of the first pipeline 551, and is connected with the diaphragm pump 553. The second pipeline 552 has a larger inner diameter than that of the first pipeline 551. Each of the first and second pipelines 551 and 552 may have through-holes 592 formed in an outer case 590 of portable communicating terminals or the electronic device etc. that incorporates the fuel cell system 500. Also, if the fuel system 500 is mounted on the portable communicating terminals or the electronic device etc., each of the first and second pipelines 551 and 552 may communicate with through holes formed in an outer case thereof.

The diaphragm pump 553 is connected to each of the first and second pipelines 551 and 552. When the diaphragm pump 553 is controlled by a pulse signal or a predetermined pressure, the external air and unreacted air are exhausted simultaneously therethrough.

In accordance with the fifth exemplary embodiment, the unreacted air exhausted through the second discharge port 513d is supplied to the first pipeline 551, and the diaphragm pump 553 is operated at a pulse pressure so that the external air is supplied to the first and second pipelines 551 and 552. As a result, each of the unreacted air and the external air are exhausted through the first and second pipelines 551 and 552 and successively through holes 592 formed in the outer case 590 of portable communicating terminals or the electronic device etc. at constant intervals. Since the unreacted air surrounded by the external air is exhausted by the through hole 592, the unreacted air can be spread out in the atmosphere away from the outer case 590.

The fuel cell system of the present invention allows unreacted air containing a large amount of high temperature steam exiting the stack to contact the atmosphere that is at a relatively lower temperature. It also allows the unreacted air to be heated by the thermal energy generated by the chemical reaction before being exhausted to the atmosphere.

Further, it inhibits the water vapor from condensing on the outer case of the portable electronic device or mobile communication terminal etc. applied with the fuel cell system of the present invention.

In addition, the fuel cell system of the present invention does not require additional devices for reusing or recovering water generated during condensation of the unreacted air which allows for a compact fuel cell system.

Finally, there is no water leakage from the stack, and the overall thermal efficiency of the system is improved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A fuel cell system, comprising:
a stack for generating electricity by a chemical reaction between hydrogen gas and oxygen;
a fuel supply portion that supplies fuel containing the hydrogen gas to the stack;
an air supply portion that supplies air to the stack; and
an air discharge portion that intermittently exhausts unreacted air that is discharged from the stack.

2. A fuel cell system, comprising:
a stack for generating electricity by a chemical reaction between hydrogen gas and oxygen;
a fuel supply portion that supplies fuel containing the hydrogen gas to the stack;
an air supply portion that supplies air to the stack; and
an air discharge portion that intermittently exhausts unreacted air and external air from the stack.

3. The fuel cell system of claim 2, wherein the air discharge portion comprises:
a first pipeline that intermittently exhausts the unreacted air; and
a second pipeline that intermittently exhausts the external air, coaxial with the first pipeline and having a larger diameter than the first pipeline.

4. The fuel cell system of claim 2, wherein the air discharge portion comprises:
a diaphragm pump.

5. The fuel cell system of claim 2, wherein the stack is incorporated into a housing that is provided with first, second, and third communicating apertures that communicate with the first fuel supply portion, the air supply portion, and the air discharge portion, respectively.

6. The fuel cell system of claim 2, wherein the stack comprises:
an electricity generator; and
a passage for heating and inflowing the external air into the housing.

7. The fuel cell system of claim 2, wherein the housing remains adiabatic.

8. The fuel cell system of claim 2, wherein the air discharge portion may be arranged within the housing.

9. A fuel cell system, comprising:
a stack for generating electricity by a chemical reaction between hydrogen gas and oxygen;
a fuel supply portion that supplies fuel containing the hydrogen gas to the stack;
a first air supply portion that supplies air to the stack;
an air mixing portion that mixes external air with unreacted air;
a second air supply portion that supplies external air to the air mixing portion; and
an air discharge portion that intermittently exhausts the mixed air from the air mixing portion.

10. The fuel cell system of claim 9, further comprising:
a fuel reformer having a first supply line that communicates with the stack.

11. The fuel cell system of claim 10, wherein the fuel supply portion comprises:
a fuel tank for storing fuel;
a fuel pump that communicates with the fuel tank; and
a second supply line that communicates with the reformer.

12. The fuel cell system of claim 9, wherein the first air supply portion further comprises:
a first air pump for taking in external air; and
a third supply line that communicates with the stack.

13. The fuel cell system of claim 9, wherein the air mixing portion further comprises:
an air mixing tank that is connected with the stack and the second air supply portion; and
a fourth supply line that communicates with the stack.

14. The fuel cell system of claim 13, wherein the second air supply portion furthercomprises:
a second air pump for taking in external air; and
a fifth supply line that communicates with the air supply line.

15. The fuel cell system of claim 9, wherein the air mixing portion is a 3-way air merging line.

16. The fuel cell system of claim 9, wherein the air discharge portion further comprises:
a third air pump; and
an air discharge line that communicates with the mixing portion respectively.

17. The fuel cell system of claim 16, wherein the third air pump may be a diaphragm pump.

18. The fuel cell system of claim 9, wherein the stack is incorporated into a housing that comprises first, second, third, fourth, and fifth communicating apertures that communicate with the fuel supply portion, the first and second air supply portions, the air mixing portion, and the air discharge portion, respectively.

19. A fuel cell system, comprising:
a stack that generates electricity by a chemical reaction between hydrogen gas and oxygen;
a fuel supply portion that supplies fuel containing the hydrogen gas to the stack;
a first air supply portion that supplies air to the stack;
a adiabatic housing that surrounds the stack;
a second air supply portion that supplies external air into the housing;
an air mixing portion that mixes the external air in the housing with unreacted air discharged from the stack; and
an air discharge portion that intermittently exhaust the mixed air from the air mixing portion.

20. The fuel cell system of claim 19, wherein the stack further comprises:
an electricity generator; and
a passage that heats and inflows external air into the housing using the heat of reaction generated by the electricity generator.
